(19) United States
(12) Patent Application Publication
(10) Pub. No.: US 2021/0044139 A1
(43) Pub. Date: Feb. 11, 2021

(54) POWER MANAGEMENT SYSTEM

(71) Applicant: Oladayo Luke, Severn, MD (US)

(72) Inventor: Oladayo Luke, Severn, MD (US)

(21) Appl. No.: 16/536,335

(22) Filed: Aug. 9, 2019

(51) Int. Cl. H02J 9/06; G06N 20/00

(52) U.S. Cl. CPC H02J 9/061; G06N 20/00

(57) ABSTRACT

Disclosed is a power management system implemented on a user device, for at least one power utilizing entity, the power management system comprising: a transfer switch, wherein the transfer switch is configured to: provide power to the at least one power utilizing entity via distribution lines; or provide power to the at least one power utilizing entity via a generator upon failure of distribution lines; a phase switch, wherein the phase switch is configured to: provide power to the at least one power utilizing entity via one or more power sources upon failure of the distribution lines and the generator; and a user device, wherein the user device is configured to enable: the transfer switch to switch between power provided via distribution lines and generator; and the phase switch to switch between power provided via one or more power sources.

### TECHNICAL FIELD

The present disclosure relates generally to power management systems; and more specifically, to power management systems implemented on user devices.

### BACKGROUND

Over the years, with development in technology, electricity has become a basic need for every device used at residential or commercial places. However, power failure by distribution lines may cause a lot of problems in operating the aforesaid devices. The power failure may be caused by many reasons such as bad weather (hurricane, tornado), distribution pole damage, transformer damage, human sabotage and the like.

Backup generators and other power sources such as solar power sources are employed to provide power when there is power failure. However, there are limitations associated with switching between distribution lines, backup generator, and other power sources. The techniques involved in switching between the distribution lines, backup generator, and other power sources are time consuming, and risky. Moreover, manual intervention makes the techniques prone to errors which may result in damaging of devices at residential or commercial places.

Therefore, in the light of foregoing discussion, there exists a need to overcome the aforementioned drawbacks associated with power management.

### SUMMARY

The present disclosure seeks to provide a power management system implemented on a user device, for at least one power utilizing entity. The present disclosure also seeks to provide a method to provide a power management system implemented on a user device, for at least one power utilizing entity. The present disclosure seeks to provide a solution to the existing problem of switching power at residential and commercial places. An aim of the present disclosure is to provide a solution that overcomes at least partially the problems encountered in prior art, and provides an automatic power switching and management system.

In one aspect, an embodiment of the present disclosure provides a power management system implemented on a user device, for at least one power utilizing entity, the power management system comprising:
a transfer switch communicatively coupled to the at least one power utilizing entity, wherein the transfer switch is configured to:
   provide power to the at least one power utilizing entity via distribution lines; or
   provide power to the at least one power utilizing entity via a generator upon failure of distribution lines;
phase switch communicatively coupled between the transfer switch and the distribution lines, wherein the phase switch is configured to:
   provide power to the at least one power utilizing entity via one or more power sources upon failure of the distribution lines and the generator; and
a user device coupled to each of the transfer switch and the phase switch, wherein the user device is configured to enable:
   the transfer switch to switch between power provided via distribution lines and generator; and
   the phase switch to switch between power provided via one or more power sources.

In another aspect, an embodiment of the present disclosure provides a method to provide a power management system implemented on a user device, for at least one power utilizing entity, the method comprises:
a transfer switch communicatively coupled to the at least one power utilizing entity, wherein the transfer switch is configured to:
   provide power to the at least one power utilizing entity via distribution lines; or
   provide power to the at least one power utilizing entity via a generator upon failure of distribution lines;
a phase switch communicatively coupled between the transfer switch and the distribution lines, wherein the phase switch is configured to:
   provide power to the at least one power utilizing entity via one or more power sources upon failure of the distribution lines and the generator; and
a user device coupled to each of the transfer switch and the phase switch, wherein the user device is configured to enable:
   the transfer switch to switch between power provided via distribution lines and generator; and
   the phase switch to switch between power provided via one or more power sources.

Embodiments of the present disclosure substantially eliminate or at least partially address the aforementioned problems in the prior art, and enables automatic power switching and power management.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a power management system implemented on a user device, for at least one power utilizing entity, in accordance with an embodiment of the present disclosure;

FIG. 2 is an exemplary implementation of a phase switch, in accordance with an embodiment of the present disclosure;

FIG. 3 is an exemplary implementation of a transfer switch, in accordance with an embodiment of the present disclosure; and

FIG. 4 illustrates steps of a method to provide a power management system implemented on a user device, for at least one power utilizing entity, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented.

Although some modes of carrying out the present disclosure have been disclosed, those skilled in the art would recognize that other embodiments for carrying out or practicing the present disclosure are also possible.

In one aspect, an embodiment of the present disclosure provides a power management system implemented on a user device, for at least one power utilizing entity, the power management system comprising:
a transfer switch communicatively coupled to the at least one power utilizing entity, wherein the transfer switch is configured to:
   provide power to the at least one power utilizing entity via distribution lines; or
   provide power to the at least one power utilizing entity via a generator upon failure of distribution lines;
a phase switch communicatively coupled between the transfer switch and the distribution lines, wherein the phase switch is configured to:
   provide power to the at least one power utilizing entity via one or more power sources upon failure of the distribution lines and the generator; and
a user device coupled to each of the transfer switch and the phase switch, wherein the user device is configured to enable:
   the transfer switch to switch between power provided via distribution lines and generator; and
   the phase switch to switch between power provided via one or more power sources.

In another aspect, an embodiment of the present disclosure provides a method to provide a power management system implemented on a user device, for at least one power utilizing entity, the method comprises:
a transfer switch communicatively coupled to the at least one power utilizing entity, wherein the transfer switch is configured to:
   provide power to the at least one power utilizing entity via distribution lines; or
   provide power to the at least one power utilizing entity via a generator upon failure of distribution lines;
a phase switch communicatively coupled between the transfer switch and the distribution lines, wherein the phase switch is configured to:
   provide power to the at least one power utilizing entity via one or more power sources upon failure of the distribution lines and the generator; and
a user device coupled to each of the transfer switch and the phase switch, wherein the user device is configured to enable:
   the transfer switch to switch between power provided via distribution lines and generator; and
   the phase switch to switch between power provided via one or more power sources.

The present disclosure provides techniques for power management and power switching between the distribution lines, generator and other power sources. The present disclosure employs user device for the power management and switching which makes the process of power management and switching easy, risk free and automatic. Moreover, errors due to manual intervention are greatly reduced.

The present disclosure provides the power management system implemented on a user device, for at least one power utilizing entity. Throughout the present disclosure, the term “power management system” as used herein refers to a combination of hardware and software components configured with programmable and non-programmable components to enable receiving, managing and distributing power. Moreover, the power management system enables in efficiently using the power available for use. The implementation of the power management system on the user device enables ease in controlling the power supplied to the at least one power utilizing entity.

Throughout the present disclosure, the term “user device” as used herein refers to an electronic device associated with or used by a user that is capable of enabling the user to perform specific tasks associated with the aforementioned system. Furthermore, the user device is intended to be broadly interpreted to include any electronic device that may be used for voice and/or data communication over a wireless communication network. Examples of user device include, but are not limited to, cellular phones, personal digital assistants (PDAs), handheld devices, wireless modems, laptop computers, personal computers, etc. Additionally, the user device includes a casing, a memory, a processor, a network interface card, a microphone, a speaker, a keypad, and a display. Moreover, the user device is to be construed broadly, so as to encompass a variety of different types of mobile stations, subscriber stations or, more generally, communication devices, including examples such as a combination of a data card inserted in a laptop.

Throughout the present disclosure, the term “at least one power utilizing entity” as used herein refers to a device which employs electricity for its functionality. In other words, the at least one power utilizing entity takes electricity as input and provides its function as an output to a given user of the at least one power utilizing entity. Optionally, the at least one power utilizing entity is implemented at a home of the given user. In an example, the at least one power utilizing entity comprises a television, a personal computer, a refrigerator, a fan, an air-conditioner, a washing machine and the like.

The power management system comprises the transfer switch communicatively coupled to the at least one power utilizing entity. Throughout the present disclosure, the term “transfer switch” as used herein refers to a switch which enables at least two power sources to be used interchangeably to provide power to the at least one power utilizing entity. Optionally, the transfer switch may be fully, partially or not controlled by manual control. Optionally, the transfer switch may be configured to automatically switch between at least two power sources based on the requirement of the at least one power utilizing entity and/or a power availability of the at least two power sources. The transfer switch is communicatively coupled to the at least one power utilizing entity via wired connections.

Moreover, the transfer switch is configured to provide power to the at least one power utilizing entity via distribution lines. Throughout the present disclosure, the term ‘distribution lines’ as used herein refers to electricity provided by a power distribution entity such as a government entity to a power consuming entity such as residential places. Optionally, three phase supply is provided via distribution lines.

Furthermore, alternatively, the transfer switch is configured to provide power to the at least one power utilizing entity via the generator upon failure of distribution lines. Optionally, the transfer switch is configured to detect the power failure of the distribution lines and consequently receive power from generator. In an example, the generator is a diesel power generator. Beneficially, the switching between the distribution lines and the generator is done in a short span of time such as 40 milliseconds to enables the at least one power utilizing power to keep functioning and not stop abruptly.

The power management system comprises the phase switch communicatively coupled between the transfer switch and the distribution lines. The term “phase switch” as used herein refers to a switch which enables in switching of power between the generator, the distribution lines and power sources. The phase switch is configured to provide power to the at least one power utilizing entity via one or more power sources upon failure of the distribution lines and the generator. Optionally, the one or more power sources are renewable power sources such as solar power sources, wind power sources, hydro power sources. In an embodiment, the one or more power sources comprises at least solar power source. Optionally, the power is obtained by employing one or more solar panels.

In an embodiment, the power management system further comprises an electric meter between the transfer switch and the phase switch. Throughout the present disclosure, the term “electric meter” as used herein refers to an electrical device employed for measuring an amount of electrical power consumed by the at least one power utilizing entity. Optionally, the electric meter enables in charging the user of the at least one power utilizing entity based on the amount of electrical power consumed. Optionally, the electric meter measures electrical power consumed by the at least one power utilizing entity in kilowatt hour.

The power management system comprises the user device coupled to each of the transfer switch and the phase switch. Optionally, the user device is coupled to each of the transfer switch and the phase switch via wired or wireless connections.

In an embodiment, the user device is connected to the transfer switch and the phase switch via a server arrangement. Throughout the present disclosure, the term “server arrangement” refers to a structure and/or module that include programmable and/or non-programmable components configured to store, process and/or share information. Optionally, the server arrangement includes any arrangement of physical or virtual computational entities capable of enhancing information to perform various computational tasks. Furthermore, it should be appreciated that the server arrangement may be both single hardware server and/or plurality of hardware servers operating in a parallel or distributed architecture. In an example, the server arrangement may include components such as memory, a processor, a network adapter and the like, to store, process and/or share information with other computing components, such as user device. Optionally, the server arrangement is implemented as a computer program that provides various services (such as database service) to other devices, modules or apparatus.

In an embodiment, the user device is connected to the transfer switch and the phase switch via at least one communication module. The term “communication module” as used herein refers to a combination of programmable and/or non-programmable components which are configured to receive information from user device and transmit the information to the transfer switch and phase switch; and/or receive information from the transfer switch and phase switch and transmit information to the user device. Optionally, the at least one communication module is present at each of the user device, the phase switch and the transfer switch. Optionally, the information comprises one or more instructions to enable functionality of the transfer switch and/or the phase switch in an instructed manner.

In an embodiment, the at least one communication module comprises at least one of Bluetooth module, Zwave module, and Global System for Mobile (GSM) module. Optionally, the Bluetooth module enables information sharing between the user device and the transfer switch and phase switch via radio waves. Optionally, Zwave module also employs radio waves for information sharing specially developed for household devices. Optionally, the Global System for Mobile (GSM) module work in a frequency range of 900 MHz and 1800 MHz.

Moreover, the user device is configured to enable the transfer switch to switch between power provided via distribution lines and generator. In an example, the user device provides information to the transfer switch for switching between the power provided via distribution lines and generator via the communication module. In an example, the user device provides such information upon high load demand on the distribution lines.

Furthermore, the user device is configured to enable the phase switch to switch between power provided via one or more power sources. In an example, the user device provides information to the phase switch for switching between the powers provided via one or more power sources via the communication module. In an example, the user device provides such information for switching from a first power switch to a second power switch.

In an embodiment, the user device further comprises machine learning based circuitry. Throughout the present disclosure, the term “machine learning based circuitry” as used herein relates to any mechanism or computationally intelligent system that combines knowledge, techniques, and methodologies for controlling a bot or other element within a computing environment. Furthermore, the machine learning based circuitry is configured to apply knowledge and that can adapt it-self and learn to do better in changing environments. Additionally, employing any computationally intelligent technique, the machine learning based circuitry is operable to adapt to unknown or changing environment for better performance. The machine learning based circuitry includes fuzzy logic engines, decision-making engines, preset targeting accuracy levels, and/or programmatically intelligent software. Optionally, the machine learning based circuitry is operable to perform all the aforesaid operations done by the user via a user device.

Optionally, the machine learning based circuitry in the context of the present disclosure relates to software-based algorithms that are executable upon computing hardware such as data processing arrangement and are operable to adapt and adjust their operating parameters in an adaptive manner depending upon information that is presented to the software-based algorithms when executed upon the computing hardware. Optionally, the machine learning based circuitry includes neural networks such as recurrent neural networks, recursive neural networks, feed-forward neural networks, convolutional neural networks, deep belief networks, and convolutional deep belief networks; self-organizing maps; deep Boltzmann machines; and stacked de-noising auto-encoders.

Optionally, the machine learning based circuitry employ any one or combination of the following computational techniques: constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing.

In an embodiment, the machine learning based circuitry is trained based on the set of instructions provided by the user device. Optionally, at an initial phase the functionality and operations of the system are controlled by the user via the user device. Moreover, upon receiving the set of instructions from the user device for a threshold number of times the machine learning based circuitry is operable to control the functionality and operations of the system by training on the set of instructions from the user at the initial phase.

In an embodiment, the machine learning based circuitry is configured to provide recommendations to a user associated with the user device. Optionally, the recommendations include trends associated with power supplied to the at least one power utilizing entity. In an example, the distribution line stops power supply to the at least one power utilizing entity everyday at 10 a.m. is a trend identified by the machine learning based circuitry. In another example, the at least one power utilizing entity identifies a trend that solar power source is available between 11 a.m. to 4 p.m. every day. Moreover, based on the recommendations the user may take necessary actions for controlling the power supplied to the at least one power utilizing entity.

The present disclosure also relates to the method as described above. Various embodiments and variants disclosed above apply mutatis mutandis to the method.

Optionally, the method comprising the one or more power sources comprises at least solar power source.

Optionally, the method comprising the user device further comprises machine learning based circuitry.

Optionally, the method comprising the machine learning based circuitry is configured to provide recommendations to a user associated with the user device.

### DETAILED DESCRIPTION OF THE DRAWINGS

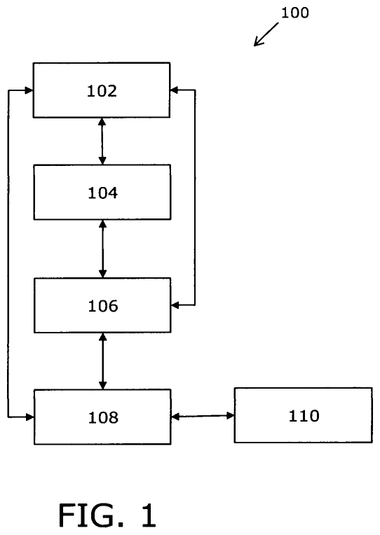

Referring to FIG. 1, illustrated is a block diagram of a power management system 100 implemented on a user device 102, for at least one power utilizing entity 104, in accordance with an embodiment of the present disclosure. As shown, the power management system 100 comprises a transfer switch 106 communicatively coupled to the at least one power utilizing entity 104; and a phase switch 108 communicatively coupled between the transfer switch 106 and distribution lines 110. Moreover, user device 102 coupled to each of the transfer switch 106 and the phase switch 108. Furthermore, the transfer switch 106 is coupled to at least one power utilizing entity 104.

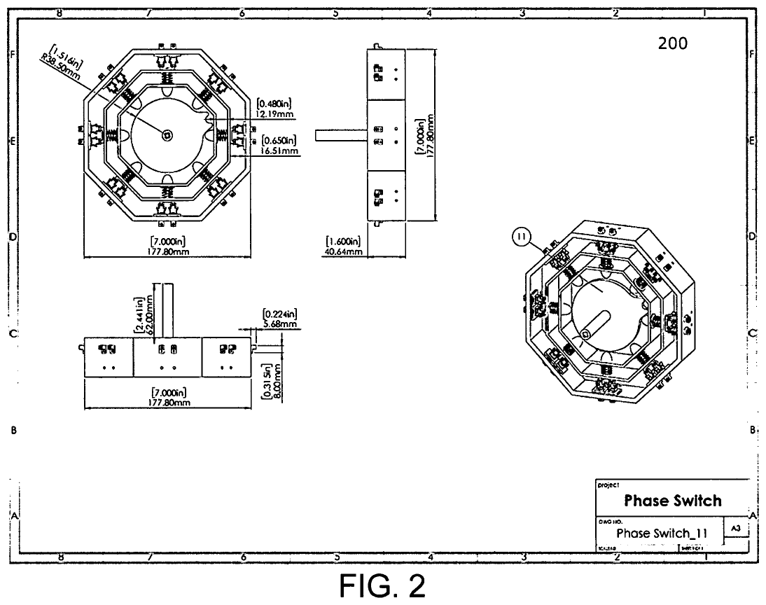

Referring to FIG. 2, illustrated is an exemplary implementation of a phase switch 200, in accordance with an embodiment of the present disclosure. The phase switch 200 provides power to at least one power utilizing entity (not shown) via one or more power sources (not shown).

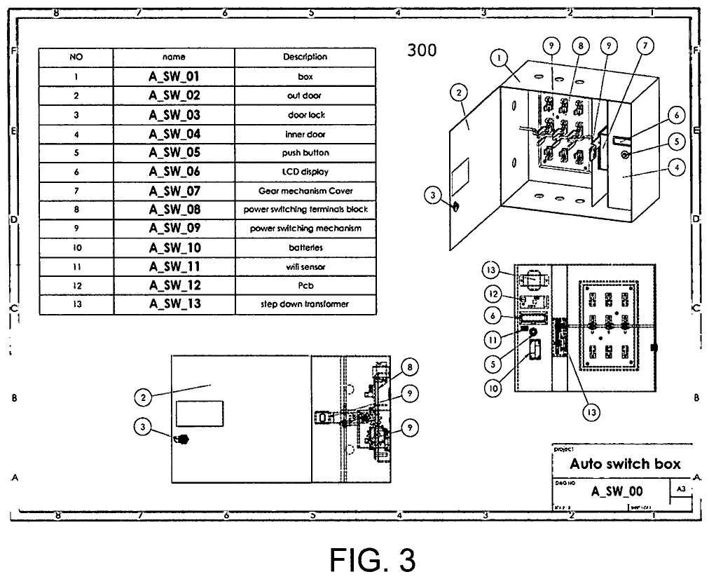

Referring to FIG. 3, illustrated is an exemplary implementation of a transfer switch 300, in accordance with an embodiment of the present disclosure. The transfer switch 300 provides provide power to the at least one power (not shown) utilizing entity via distribution lines (not shown) or provide power to the at least one power utilizing entity via a generator (not shown) upon failure of distribution lines.

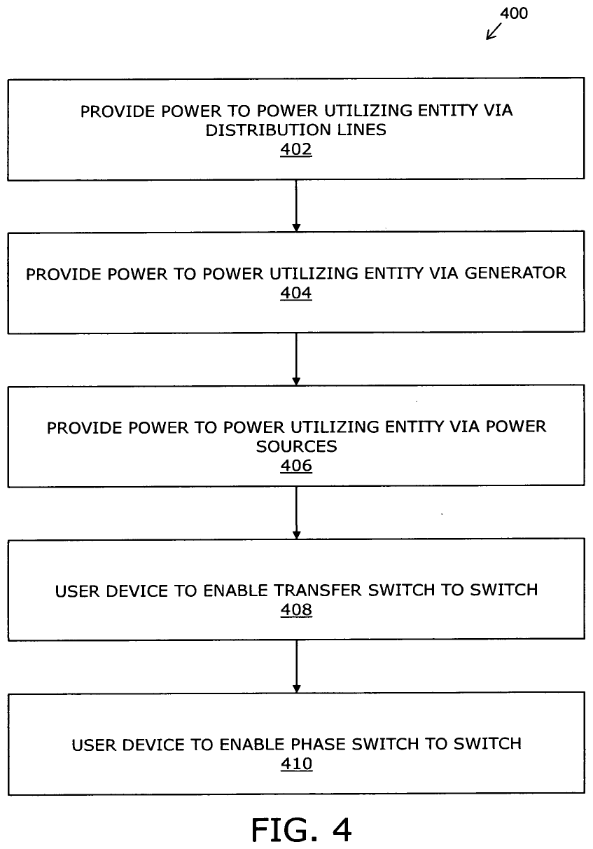

Referring to FIG. 4, illustrated is steps of a method 400 to provide a power management system implemented on a user device, for at least one power utilizing entity, in accordance with an embodiment of the present disclosure. At a step 402, a transfer switch provides power to the at least one power utilizing entity via distribution lines. At a step 404, transfer switch provides power to the at least one power utilizing entity via a generator. At a step 406, a phase switch provides power to the at least one power utilizing entity via one or more power sources upon failure of the distribution lines and the generator. At a step 408, a user device enables the transfer switch to switch between power provided via distribution lines and generator. At a step 410, a user device enables the phase switch to switch between power provided via one or more power sources.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A power management system implemented on a user device, for at least one power utilizing entity, the power management system comprising:
a transfer switch communicatively coupled to the at least one power utilizing entity, wherein the transfer switch is configured to:
provide power to the at least one power utilizing entity via distribution lines; or
provide power to the at least one power utilizing entity via a generator upon failure of distribution lines;
a phase switch communicatively coupled between the transfer switch and the distribution lines, wherein the phase switch is configured to:
provide power to the at least one power utilizing entity via one or more power sources upon failure of the distribution lines and the generator; and
a user device coupled to each of the transfer switch and the phase switch, wherein the user device is configured to enable:
the transfer switch to switch between power provided via distribution lines and generator; and
the phase switch to switch between power provided via one or more power sources.

2. The power management system according to claim 1, wherein the power management system further comprises an electric meter between the transfer switch and the phase switch.

3. The power management system according to claim 1, wherein the one or more power sources comprises at least solar power source.

4. The power management system according to claim 1, wherein the user device is connected to the transfer switch and the phase switch via a server arrangement.

5. The power management system according to claim 1, wherein the user device is connected to the transfer switch and the phase switch via at least one communication module.

6. The power management system according to claim 5, wherein the at least one communication module comprises at least one of Bluetooth module, Zwave module, and Global System for Mobile (GSM) module.

7. The power management system according to claim 1, wherein the user device further comprises machine learning based circuitry.

8. The power management system according to claim 1, wherein the machine learning based circuitry is configured to provide recommendations to a user associated with the user device.

9. A method to provide a power management system implemented on a user device, for at least one power utilizing entity, the method comprises:
a transfer switch communicatively coupled to the at least one power utilizing entity, wherein the transfer switch is configured to:
provide power to the at least one power utilizing entity via distribution lines; or
provide power to the at least one power utilizing entity via a generator upon failure of distribution lines;
a phase switch communicatively coupled between the transfer switch and the distribution lines, wherein the phase switch is configured to:
provide power to the at least one power utilizing entity via one or more power sources upon failure of the distribution lines and the generator; and
a user device coupled to each of the transfer switch and the phase switch, wherein the user device is configured to enable:
the transfer switch to switch between power provided via distribution lines and generator; and
the phase switch to switch between power provided via one or more power sources.

10. The method according to claim 9, wherein the one or more power sources comprises at least solar power source.

11. The method according to claim 9, wherein the user device further comprises machine learning based circuitry.

12. The method according to claim 9, wherein the machine learning based circuitry is configured to provide recommendations to a user associated with the user device.
